(19) United States
(12) Patent Application Publication
(10) Pub. No.: US 2007/0168725 A1
(43) Pub. Date: Jul. 19, 2007

(54) SYSTEM AND METHOD FOR REBOOTING A COMPUTER AUTOMATICALLY WHEN A SYSTEM CRITICAL ERROR OCCURS

(75) Inventor: MING-CHE LEE, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,419

(22) Filed: Aug. 4, 2006

(30) Foreign Application Priority Data
Nov. 14, 2005 (CN) 200510101497.7

(51) Int. Cl. G06F 11/00

(52) U.S. Cl. 714/23

(57) ABSTRACT

A system for rebooting a computer automatically when a system critical error occurs is disclosed. The system includes: a timer (201) for counting down from a preset initial time when started, and for sending a reset signal to restart the computer (10) if the timer (201) counts down to zero; and a reset device (30) for setting a reset time, and for resetting the timer (201) when the reset time elapses. A related method is also disclosed.

### 1. FIELD OF THE INVENTION

The present invention relates to booting technique of a computer, particularly to a system and method for rebooting a computer automatically when a system develops critical errors.

### 2. DESCRIPTION OF RELATED ARTS

The ongoing development in computer systems has yet to develop a resource management system that prevent critical errors, causing an entire computer system to fail. Critical errors occur when a resource is held and not released crippling the entire computer system, often leaving millions of dollars of equipment idle and frustrating its users.

To recover, computer systems are manually rebooted. However, if an administrator of the computer system is not available, it may be hours or even days before the administrator arrives onsite to manually restart the computer system.

Therefore, what is needed is a system and method for rebooting a computer automatically when a system critical error occurs.

### SUMMARY OF THE INVENTION

A system for rebooting a computer automatically when a system critical error occurs includes: a timer for counting down from a preset initial time when started, and for sending a reset signal to restart the computer if the timer counts down to zero; and a reset device for setting a reset time, and for resetting the timer when the reset time elapses.

A related method for rebooting a computer automatically when a system critical error occurs includes the steps of: setting a initial time for a timer; setting a reset time for a reset device; starting the timer, the timer counting down from the initial time; resetting the timer if the reset time elapses; and sending a reset signal to restart the computer if the timer counts down to zero.

Other advantages and novel features of the embodiments will be drawn from the following detailed description with reference to the attached drawings.

### BRIEF DESCRIPTION OF THE DRAWINGS

FIG. 1 is a schematic diagram of a hardware configuration of a system for rebooting a computer automatically when a system critical error occurs in accordance with a preferred embodiment;

FIG. 2 is flowchart of a preferred method for rebooting a computer automatically when a system critical error occurs by utilizing the system of FIG. 1.

### DETAILED DESCRIPTION OF THE INVENTION

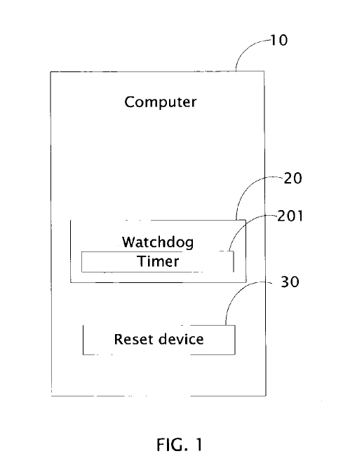

FIG. 1 is a schematic diagram of a hardware configuration of a system for rebooting a computer automatically when a system critical error occurs (hereinafter, “the system”) in accordance with a preferred embodiment. The system includes a watchdog 20 and a reset device 30 configured in a computer 10. The computer 10 may be a personal computer (PC) or a notebook computer. The watchdog 20 includes a timer 201 that is set with an initial time. The timer 201 tracks an elapsed time and sends a reboot signal to restart the computer 10 when the initial time equals to the elapsed time. The reset device 30 is used for setting a reset time, and further used for resetting the timer 201 when the elapsed time equals to the initial time. Herein, the reset time is less than the initial time. If the computer 10 is not in a system critical error state, the reset device 30 resets the timer 201 when the reset time elapses. Otherwise, if the computer 10 is in a system critical error, the reset device 30 is unable to reset the timer 201 when the elapsed time equals to the reset time. The timer 201 thus, continues to keep track of the elapsed time, and sends the restart signal to restart the computer 10 when the elapsed time equals to the initial time.

The implementation of the system can be better illustrated by an example as follows. The initial time is set at 4 minutes and 50 seconds via the watchdog 20 and the reset time is set at 4 minutes and 40 seconds via the reset device 30. The timer 201 is started and tracks the elapsed time. If the computer 10 is not in a system critical error state, the reset device 30 resets the timer 201 when 4 minutes and 40 seconds elapses. In other words, if the computer 10 is not in a system critical error state, the timer 201 the elapsed time is never equal to the initial time. Otherwise, if the computer 10 is in a system critical error state, the reset device 30 is unable to reset the timer 201 when the elapsed time equals to the initial time. The timer 201 continues tracking the elapsed time until the elapsed time equals to the initial time and sends the restart signal to restart the computer 10.

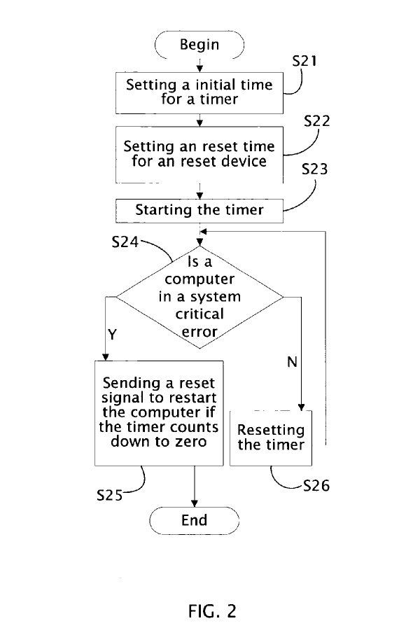

FIG. 2 is a flowchart of a preferred method for rebooting a computer automatically when the system critical error occurs by utilizing the system of FIG. 1. In step S21, The initial time is set for the timer 201 via the watchdog 20. In step S22, The reset time is set for the reset device 30. The reset time is configured to be less than the initial time. In step S23, the timer 201 starts and begins tracking the elapsed time. In step S24, the computer 10 determines if it is in a system critical error. If the computer is in the system critical error, in step S25, the reset device 30 is unable reset the timer 201. Then, the timer 201 continues tracking an elapsed time until the elapsed time equals to the initial time and sends the restart signal to restart the computer 10. Otherwise, if the computer is not in the system critical error, in step S26, the reset device 30 resets the timer 201 when the elapsed time equals to the reset time, whereafter the procedure returns to step S24 described above.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for rebooting a computer automatically when a system critical error occurs, the system comprising:
a timer for counting down from a preset initial time when started, and for sending a reset signal to restart the computer if the timer counts down to zero; and
a reset device for setting a reset time, and for resetting the timer when the reset time elapses.

2. The system according to claim 1, wherein the reset time is less than the preset initial time.

3. The system according to claim 1, wherein the reset device cannot resets the timer if the computer is in a system critical error.

4. A method for rebooting a computer automatically when a system critical error occurs, the method comprising the steps of:
setting a initial time for a timer;
setting a reset time for a reset device;
starting the timer, the timer counting down from the initial time;
resetting the timer if the reset time elapses; and
sending a reset signal to restart the computer if the timer counts down to zero.

5. The method according to claim 4, wherein the reset time is less than the preset initial time.

6. The method according to claim 4, wherein the timer counts down to zero when the computer is in a system critical error.
